(19) United States
(12) Patent Application Publication
(10) Pub. No.: US 2019/0378120 A1
(43) Pub. Date: Dec. 12, 2019

(54) SYSTEM AND METHOD FOR USER IDENTIFICATION AND AUTHENTICATION

(71) Applicant: BANQUE NATIONALE DU CANADA, Montreal (CA)

(72) Inventors: Olivier BERROD, Montreal (CA); Christopher SEBASTIEN, Montreal (CA); Roger MILLER, Montreal (CA)

(73) Assignee: BANQUE NATIONALE DU CANADA, Montreal (CA)

(21) Appl. No.: 16/436,535

(22) Filed: Jun. 10, 2019

(30) Foreign Application Priority Data
Jun. 8, 2018 (CA) 3007798

(51) Int. Cl. G06Q 20/36; G06Q 20/10; G06Q 20/38

(52) U.S. Cl. CPC G06Q 20/3674; G06Q 20/3821; G06Q 20/108

(57) ABSTRACT

A method for an institution to open an account for a user is provided. The method notably comprises receiving a request from the user to open the account with the institution. The user is asked, via a digital channel, for a payment from a digital wallet of the user. The identification of the user is performed at least in part by receiving information about the user from the digital wallet of the user and using an identification method that is associated with the digital wallet. The authentication of the user is performed by comparing at least two sets of information, one received from the digital wallet and one inputted by the user. The account with the institution is then opened and a payment request is made from the digital wallet to an issuing bank of the user.

### FIELD OF THE INVENTION

The invention relates to methods, systems and individual components thereof for performing identification and authentication of a user. In particular, the invention relates to a system and method for identifying and authenticating a user in the process of opening a new account with an institution.

### BACKGROUND OF THE INVENTION

The advent of digital commerce has seen a staggering increase in the speed, reliability and convenience of online transactions. Using online and mobile banking services, interbank networks and payment service provider solutions, individuals can transfer funds from their own bank accounts to almost any other institution account in the world in a matter of seconds, and at the click of a few buttons. This speed and accessibility is however predicated on the use of pre-existing accounts associated with known natural or legal persons.

The typical process for establishing an account, for example a bank account, remains relatively labour intensive and time consuming. In most cases, an individual is required to present themselves at a bank branch and to bring photo identification (e.g. passport and/or drivers licence) to all allow the bank to link a new bank account to a genuine identity (identification), and to ensure that the genuine identity is associated with that individual (authentication). Moreover, in order to establish the accuracy of their personal details (e.g. address, Social Insurance/Security Number), an individual is typically required to show multiple pieces of corroborating evidence (e.g. bills/invoices, utility company account statements and/or government correspondence) sourced from a plurality of different third parties.

In order to reduce the above burden, some institutions have made it possible to open accounts online, by providing electronically scanned copies of documentary evidence and/or inputting personal details into an online form. While these efforts do partially reduce the burden on the individual applying for an account, the institution's burden remains, as most electronically scanned documents still require review by an institution employee. Moreover, these online solutions introduce a significant security risk, as individuals are typically asked to submit personal information (e.g. full name, date of birth, address, Social Insurance/Security Number, etc.) into a single web form, for unsecured transmission over the Internet.

Accordingly, there remains a need for a fast, convenient and secure method and system of identifying and authenticating an individual applying for a new account with an institution online.

### SUMMARY OF THE INVENTION

In accordance with one non-limiting embodiment, there is provided a method for an institution to open an account for a user, the method comprising receiving a request from the user to open the account with the institution; asking the user, via a digital channel, for a payment from a digital wallet of the user; identifying the user at least in part by receiving information about the user from the digital wallet and using an identification method associated with the digital wallet; and opening the account with the institution, wherein a payment request is made from the digital wallet to an issuing bank of the user after the identifying of the user.

In accordance with another non-limiting embodiment, there is provided a method for an institution to open an account for a user, the method comprising receiving a request from the user to open the account with the institution; requesting a payment from a digital wallet of the user; identifying the user based on (i) at least one set of information received from an information repository of the user and (ii) at least one set of information inputted by the user; comparing the at least one set of information received from the information repository and the least one set of information inputted by the user; authenticating the user when the comparing meets a pre-determined threshold and opening the account with the institution.

In accordance with another non-limiting embodiment, there is provided a method for an institution to open an account for a user, the method comprising receiving a request from the user to open the account with the institution; requesting a payment from a digital wallet of the user; identifying the user based on a plurality of sets of information received from a plurality of information repositories of the user; comparing the plurality of sets of information received from the information repositories; authenticating the user when the comparing meets a pre-determined threshold and opening the account with the institution.

### BRIEF DESCRIPTION OF THE DRAWINGS

A detailed description of example implementations of the present invention is provided below, with reference to the following drawings, in which:

FIG. 1 shows a flowchart illustrating steps in a method for identifying and authenticating a user for the purpose of opening an account with an institution online in accordance with one embodiment;

FIG. 2 shows a high-level block diagram of a system for identifying and authenticating a user according to the method of FIG. 1 in accordance with one embodiment;

FIG. 3 shows a detailed flowchart illustrating steps in a method for identifying and authenticating a user for the purpose of opening an account with an institution online in accordance with another embodiment;

FIG. 4 shows a high-level transaction diagram relating to a backend system and method for identifying and authenticating a user for the purpose of opening an account with an institution online in accordance with another embodiment;

FIG. 5A shows a diagram of an example user interface showing a web form and graphical control elements arranged to enable a user to request an account opening in accordance with one embodiment;

FIG. 5B shows a diagram of an example user interface showing a web form and graphical control elements arranged to enable a user to activate a payment option in accordance with one embodiment; and

FIG. 6 shows a high-level transaction diagram relating to backend systems and methods for identifying and authenticating a user for the purpose of opening an account with an institution online in accordance with yet a further embodiment.

### DETAILED DESCRIPTION

The term identification is used herein as referring to the association of a name or other information to a specific person, while the term authentication is used herein as referring to the process of proving, to a standard acceptable to an institution wishing to authenticate a person, that the person who has identified himself or has been identified is indeed the person described in the identification. It is appreciated that proving that a specific person identified as user is genuinely who that person claims to be may be achieved in a number of ways, as further described below, some being acceptable only in certain industries, for example using copies of identification cards, using answers to personal questions previously answered by the person, bio-metric identification, using a witness, etc.

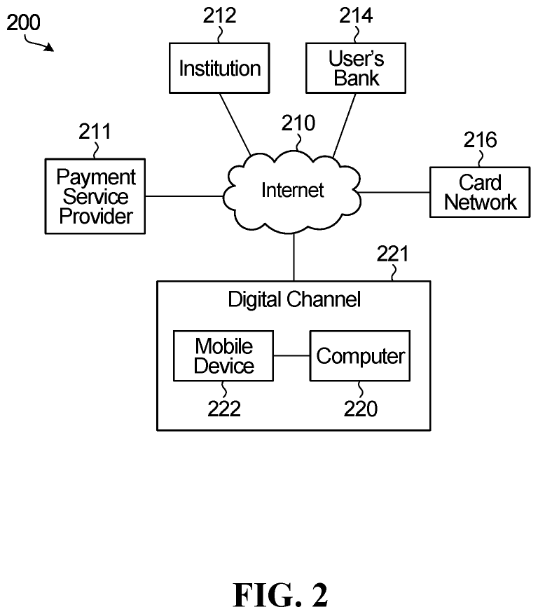

FIG. 2 is a high-level block diagram of a system 200 for identifying and authenticating a user for the purpose of opening an account with an institution online in accordance with one non-limiting embodiment. The system 200 notably comprises a Payment Service Provider (“PSP”) 211, an institution 212, a user's financial institution 214 (e.g. a bank), a card network 216, and a digital channel 221 made available to a user to communicate with the institution, all of the above components of the system 200 being connected to the internet 210. The PSP 211, institution 212, user's financial institution 214, card network 216 each operate one or more servers under their control and in communication through the internet 210 with each other and the digital channel 221. The functionality described herein is carried out by these servers in communication with the digital channel using well known means of communication. In some non-limiting examples, the institution 212 may be any institution that needs to identify and authenticate its users (i.e., its clients), such as but not limited to a financial institution (e.g., a bank), a government agency, any service provider such as phone and/or cable and/or internet service providers, private health care providers, insurers and the like. Any other suitable component may be present in the system 200 in other embodiments. A variety of digital channels 221 may be available to a user to communicate with an institution, including without limitation a website, a mobile application, an API, or user interface (on a mobile device 222, computer 220, laptop, wearable or any other electronic device), a virtual reality interface, a voice assistant or any other means of interacting with a server in data communication with the internet 210.

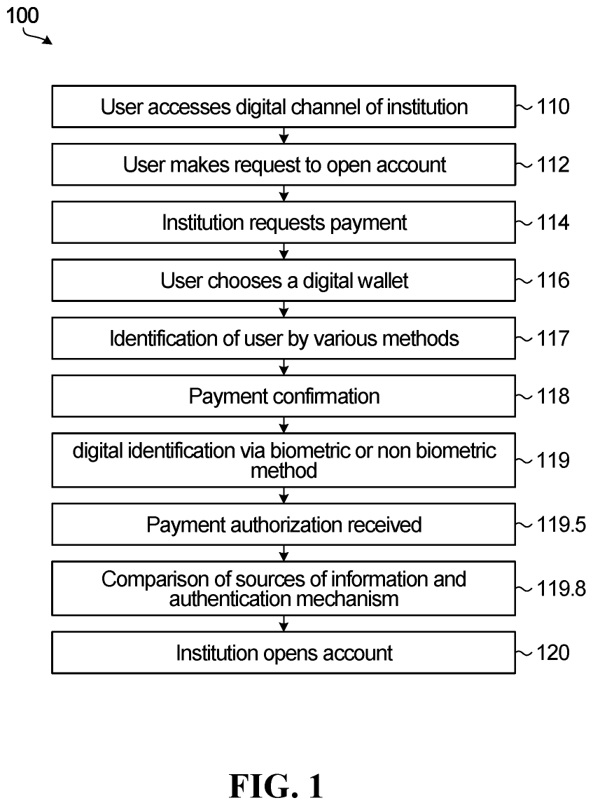

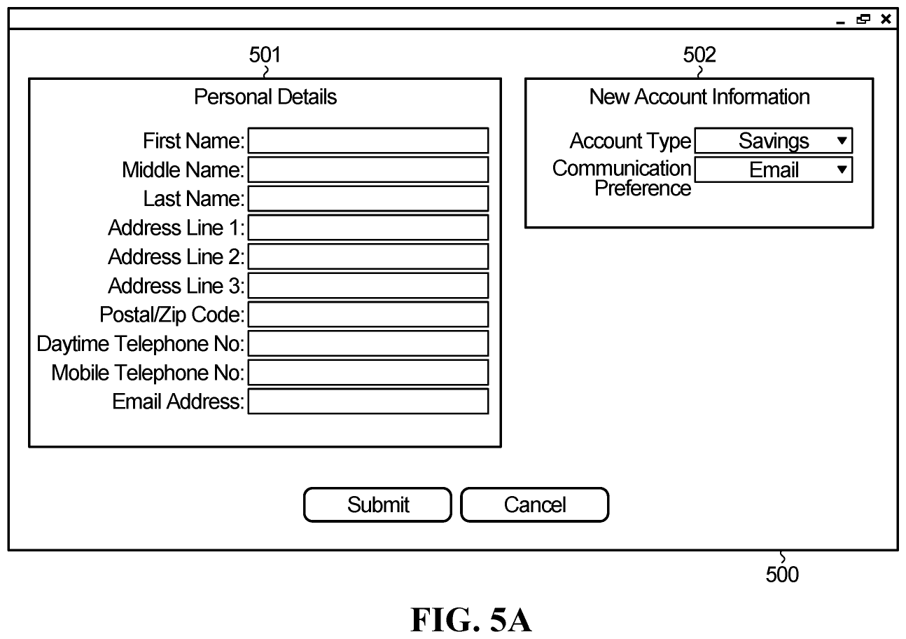

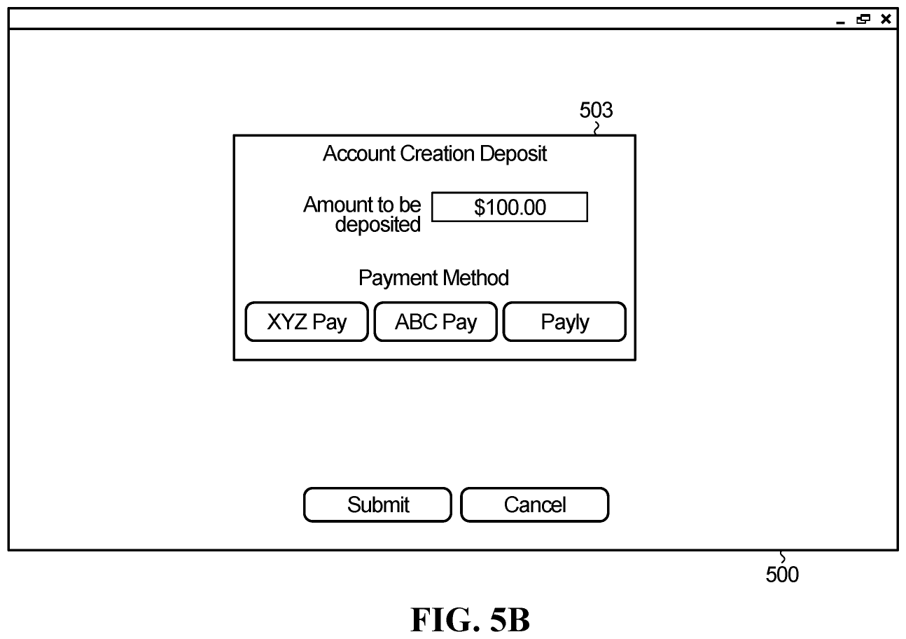

FIG. 1 shows a method 100 for identifying and authenticating a user for the purpose of opening an account online with an institution that receives payments from its clients, in accordance with a non-limiting embodiment. The method 100 may be implemented on the system 200. With reference to the method 100, at step 110 the user accesses a digital channel 221 of the institution 212 at which the user wishes to open an account. The digital channel 221 of the institution 212 may be accessed by any suitable means, such as but not limited to by way of a browser on the computer 220 or on the mobile device 222 which is in data communication with the Internet 210, or via an application running on the computer 220 or running on the mobile device 222. In this example, at step 112, the user makes a request to open the account with the institution 212 via the digital channel 221 of the institution 212, as described above. It is appreciated that, at step 112, the user may be prompted to enter information related to the user such as, but not limited to, the user's name, the user's address, email, postal code or zip code, etc. as further described below with respect to FIG. 5. This information provides a first means of identifying the user, namely information provided by the user himself in an application process to open the account with the institution and therefore such information is reliant upon input by the user concurrently with, or substantially concurrently with, the performance of step 112.

Alternatively the user may be prompted only to choose the type of account the user wishes to open (for example choosing amongst one of a plurality of checking, credit card and savings accounts, if the institution is a financial institution or different voice and data plans if the institution is a cellular service provider), such choice triggering step 114 below, without further receipt by the institution of information related to the user.

At step 114, upon receipt of the request to open an account at step 112, the institution 212 processes the account opening request and returns to the user via the digital channel 221 a request for payment via one or more digital wallets. The request for payment provides the user with a choice of one or more digital wallets which may have various forms in various examples. In one non-limiting example, the choice of digital wallets may be one or more buttons that are made available to the user through the payment request generated on the digital channel 221 at step 114, as further described below. The choice of digital wallets may have any other suitable forms in other examples (e.g., it may be a link shared via email, a notice on a mobile device or a website, etc.). For example, the user may be presented with a button labelled “Pay with Google Pay” and/or another button labelled with “Pay with Apple Pay”.

At step 116, the user chooses a digital wallet in response to the request for payment received by the user at step 114 via the digital channel 221. Subsequently to step 116, when the user chooses one of the one or more digital wallets via the buttons described above, an information request is made to an information repository, one purpose of which is to identify the user who chose the digital wallet at step 117 using various methods, as further described below. As such, the information request may take various forms and may be directed to a variety of information repositories. In one non-limiting example, the information repository may be linked to the digital wallet chosen by the user, the digital wallet being used in enabling the user to carry out the payment request as described above. As such, one of the buttons that is made available to the user as a choice of one or more digital wallets at step 116 is functionally connected to the digital wallet of the user such that the activation of the button enables the user to subsequently select a payment option offered by the digital wallet of the user, as further described below

The digital wallet may comprise a mobile application running on the user's mobile device 222 connected to a remote server in one non-limiting example, however any other suitable digital wallet may be used in other non-limiting examples, such as a digital wallet comprising an application running on the computer 220 connected to a remote server or on any other digital channel 221. The digital wallet is typically associated with, and comprises information pertaining to, at least one payment option of the user, such as, but not limited to, at least one of a credit card (VISA, MasterCard, American Express, Discover Card, etc.), a debit card (for instance issued by a bank), a pre-paid card, a gift card associated with a retailer, and the like. For example, a user may have associated his VISA credit card, a debit card issued by Bank ABC and a gift card associated with Store XYZ to his digital wallet. As such payment via all three cards is available to the user through the digital wallet.

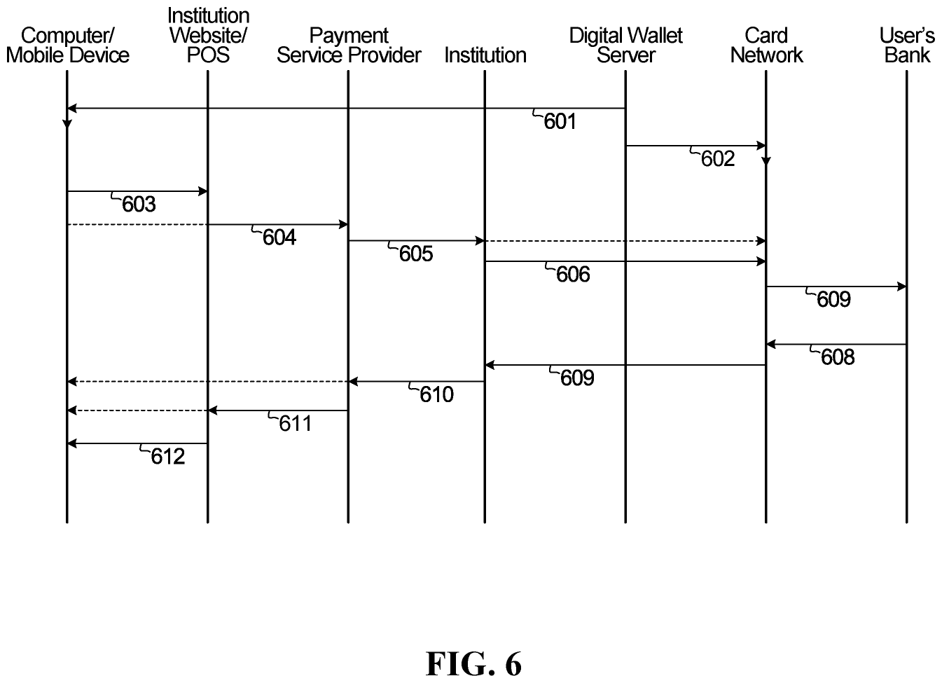

In this example, it will also be appreciated that the user has previously entered the relevant and required information into the user's digital wallet (for example, into the mobile application running on the user's mobile device 222 or the software running on the user's computer 220), the information pertaining to the at least one of the payment options associated with the digital wallet chosen and that the payment options have been previously confirmed by the user's digital wallet by any suitable means (e.g., the name of the user, the address and postal code, CSV, etc.) with the payment option's issuing bank. Such confirmation may be performed by or on behalf of the digital wallet operator by communicating with the payment option's issuing bank and confirming the existence of the related account and availability of funds. After such confirmation, as further described below notably in relation to FIG. 6, the remote server of the digital wallet may have created, for each one of the at least one payment options, a token and a plurality of cryptogram passwords associated with the particular payment option and representing the credit card or debit card number and will have forwarded the token and plurality of cryptogram passwords to the mobile application or software running on the user's mobile device 222 or computer 220 or any other suitable digital channel 221, where the token and the plurality of cryptogram passwords may be stored or otherwise available. In addition, the digital wallet may store information related to the user, such as his name, email address, address, zip or postal code, etc. as well as a limited number of digits from payment cards that the user associated with the digital wallet (for example the last 4 digits of a credit card associated with the digital wallet by the user) and may make any of this information available through the digital channel 221 to the user and the institution 212, for example through the application or website running on the user's mobile device 222 or computer 220. It will be understood that other methods of storing and communicating payment and information related to the user in a digital wallet may be used as well.

Returning to step 116, when the user selects a payment option available in the chosen digital wallet, the digital wallet may return at step 117, via the digital channel 221 (for example, the website or application running on the user's mobile device 222 or computer 220), one or more of the user's name, email address, shipping address, postal or zip code or other information, some digits associated with the chosen payment option card, along with a request to confirm payment. For example, the user may be shown a UI comprising his email, his name, his shipping address, the last 4 digits of the VISA card he selected as a payment option, and a button requesting confirmation of payment. This information therefore provides a second means of identifying the user at step 117, based on information associated with the user's digital wallet, and therefore may alleviate the need for the user to enter any information at step 112 in some non-limiting examples. The institution's website or any other suitable digital channel 221 therefore can collect and provide the institution's servers with information related to the user without the user needing fill boxes on a website asking for information. It is appreciated that such information is not reliant upon any input by the user concurrently with, or substantially concurrently with, step 116 to identify the user at step 117. The identification of the user at step 117 may be based upon a variety of information sources that may or may not require any input from the user, as further described below.

In some non-limiting examples, the user may be identified at step 117 by obtaining, via the digital channel 221, such as the application running on the user's mobile device 222 or on the user's computer 220, information related to the user. For example, this could include contacts stored in the application on the mobile device 222 or on the computer 220, or servers linked to the mobile device or computer, for instance the user's own contact profile. In addition, this information could include the user's location, digital channel's 221 IP address, operating system (type and version), browser (type or version) etc.

In other non-limiting examples, the user may also be identified at step 117 by obtaining, via a third-party information provider, information about the user. For example, using the name obtained when the user completed the information at step 114, or from the mobile device or computer, or from the digital wallet, a credit check provider may return information related to that person's name, such as address, zip or postal code, employment history, banks utilized by the person, last four digits of accounts held by the person, etc. Other sources of third party information may include other institutions that may have relationships with the user, aggregators of information (such as information repositories listing court proceedings), credit bureaus, government data repositories, a data repository containing information about and controlled by the user, and the web via an appropriate search engine. Such third party provided information may be used as described below to authenticate the user.

In other non-limiting examples, the user may also be identified at step 117 by prompting the user to provide an additional source of information, for instance by scanning an identification card belonging to the user (e.g., a driver's license, etc.) and/or by recording a video or an image of the face or recording the voice of the user in order to compare the image or video to images of the user on the identification card or elsewhere or the voice to another recorded voice. The person's image, video or voice recording may be made via the digital channel 221, whereby the information is sent over the internet 210 to a server of the institution 212. Identification cards may list a person's name, an address, an age, a gender, and an image of the person, along with numbers specific to the identification card (such as a driver's license number, a social security number, a health account number, etc.). The person's image recorded by the digital channel 221 may be compared with the image on the identification card to ascertain whether they are the same person.

Once the payment option has been selected, in order for the user to confirm the payment at step 118, the digital wallet may optionally provide a functionality for the user to identify himself via a biometric or non-biometric input at step 119. The biometric input may be a mechanism available on the digital channel 221 (for example running on the mobile device 222), such as physical biometrics (e.g., fingerprint recognition, facial recognition or retina scanning and voice recognition, liveness detection, etc.) as well as behavioural biometrics (e.g., keystroke dynamics, pulse analysis, signature analysis, etc.). For example, a Touch ID or Face ID feature may be used on an Apple® mobile device 222. In other non-limiting examples, when the user is using the user's computer 220, the user identification mechanism may be a biometric-based user identification mechanism on the computer 220, for example a facial recognition or fingerprint functionality available on the computer 220. Alternatively, a user using a computer 220 may still rely on a biometric-based user identification mechanism on the mobile device 222 or a wearable device (e.g. a watch), that is, in this example, remotely connected to the computer 220 being used by the user (e.g., via Bluetooth, Wi-Fi, Near Field Communication (NFC) or any other suitable electromagnetic transmission technology or through the internet). For example, a wearable device (e.g., a smart watch) may rely on a biometric-based user identification mechanism from a mobile device 222 (e.g., a mobile phone) connected to the wearable device—in this example, the wearable device may require identification when the wearable device is first put on by a user via the mobile device (e.g., the user identifies via fingerprint recognition, facial recognition or retina scanning at the time the smart watch is put on) and then the identification remains valid for as long as the wearable device is worn by the user. In this example, the wearable device may be equipped with a continual skin contact detection system and the identification remains valid up until the continual skin contact detection systems determines that the wearable device has been removed by the user.

In other non-limiting examples, the digital wallet may provide a functionality for the user to identify himself that is not biometric based. For example, the user may be prompted to enter a user-specific computer password when the user's digital wallet identification mechanism is associated with a computer 220 that does not support biometric identification. In another example, the user may be prompted to enter a code on the computer 220 which was previously communicated to the mobile device 222 via text or messaging (e.g. two factor authentication etc.). In another example, the user may be prompted on his mobile device 222 or wearable to acknowledge that the user has attempted to access his digital wallet on another device (in this example his computer 220) by clicking on a button on the mobile device 222 or wearable. It will be further appreciated that the digital wallet-based identification (biometric or not) concurrent with step 118 may be performed without receiving any information from the user account at the user's bank 214 from which the payment is to be made and, as such, the identification may not be reliant upon the payment.

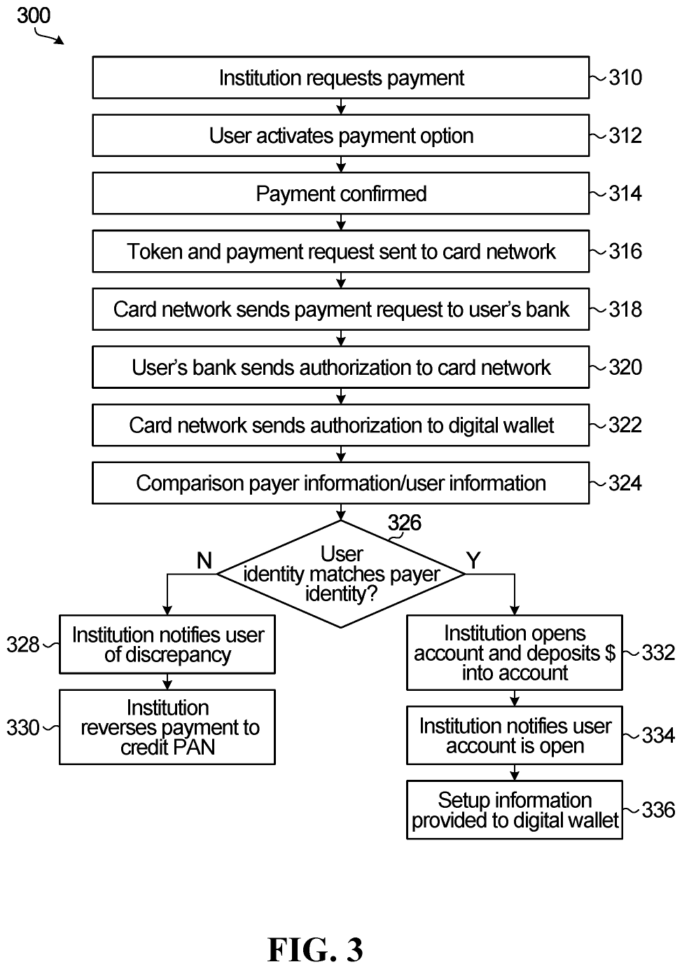

Once the payment is confirmed by the user at step 118, the payment request is made to the user's bank 214 via the PSP 211 and card network 216 as further described below, in relation to FIG. 3. If the user's bank 214 authorises the payment, an authorisation message and/or payment information may be sent back to the institution 212 at step 119.5, again via the PSP 211 and card network 216 as further described below. The payment information may include information related to the user and payer identity information. Payer identify information is defined herein as any suitable information relating to the identity of the payer. Such information can include, but is not limited to, the full name, address, email, phone number, and postal/ZIP code of the payer and/or banking details of the payer, such as the bank ID and/or all of part of the bank account details of the account used by the payer to make the payment. If the payment information is received by the institution 212, the institution 212 may then extract some or all of this payer identity information from the received payment information. This information about the user provides another source of information. Therefore, it is appreciated that a variety of sources of information may be used to identify the user at a variety of stages of the method 100, as described above, some of these sources being reliant upon some form of user input concurrently with, or substantially concurrently with, with the performance of the method 100, while others are not reliant upon such user input.

In addition, if the institution receives the authorisation message from the user's bank (via the PSP 211 and card network 216) the institution knows that the user has accessed a digital wallet with a valid payment option that has previously been authenticated by another bank (in this instance the user's bank 214), that the user's account at the user's bank 214 is in good standing, and that the user has access to sufficient funds in the user's account for the payment.

With the information from the various sources of information about the user, reliant or not upon user input, as well as the digital wallet-based identification and the authorisation message from the user's bank 214, an authentication mechanism will seek to authenticate the user applying for a new account at the institution 212. Such authentication mechanism may be based on a comparison between at least 2 sources of information about the user. In one non-limiting example, one of the at least 2 sources of information corresponds to information either entered by the user at step 112, obtained from the digital wallet at step 116 or obtained at step 117, the information obtained from the biometric scan via the digital channel 221 at step 119, the third party information, the user's bank's authorisation message, and the user's bank's payment information (if any) and the likes. The authentication mechanism carries out an assessment of an overlap between the information from the at least 2 sources of information. For example, source A may correspond to information either entered by the user at step 112 or obtained from the digital wallet at step 116 and source B may correspond to payment information relating to the holder of the account with the user's bank 214 from which the payment is to be made. At step 119.8, a comparison between the information from source A and source B may be made, and after the comparison is performed a decision may be made as to whether the account is opened based on a pre-determined, required overlap between the information from source A and source B. For instance, it may be required that a threshold of overlap between information from source A and source B be 100% (i.e., the information from source A and source B is completely identical), However this threshold may be set to any other suitable value in other non-limiting examples. Also, when there are some differences in terms of the informational content of source A and source B (for instance, when source A includes an apartment number while source B does not include an apartment number), such discrepancy may or may not be taken into account when assessing the overlap between information from source A and source B. Assuming now that a source C is available and corresponds to information gathered from a third party source such as a credit bureau (e.g., Equifax, TransUnion, etc.), a first assessment may be performed as between source A and source B, a second, separate assessment may be performed as between source A and source C, and then a decision may be made open the account on the basis that both the first and second assessments meet the specific threshold. However, in other non-limiting examples, a unique assessment may be performed at the same time as between source A and source B and source C. As another example, it may be required that the name obtained from source A, B and C be exactly the same, and that other information match only between two sources (e.g. source A and B's same postal code matches but source C does not, is an acceptable comparison if all sources have the same name).

It will be appreciated that the authentication mechanism may function in any suitable manner. For example, (i) any number of sources of information may be used as long as there are at least 2 sources of information; (ii) within each source of information being used, any number of parameters within the relevant data set may be used; (iii) when comparing the parameters between the relevant data sets, any suitable threshold may be used. With respect to (ii), the data sets within each source of information may comprise non-overlapping parameters (e.g., not all sources of information may store the address of the user), however overlapping parameters ought to be selected to perform the authentication. As such, overlapping parameters between the 2 data sets may first be identified, and then any suitable number of matching parameters may be selected. These user-specific parameters may include, but not be limited to: a first name and last name, an address, an age, a social insurance number, an employer (and date of beginning of employment), a credit card number, a bank account number (and date of opening of the account, including the type of account). With respect to (iii), the selected, matching parameters may then be compared one by one and a pre-determined threshold may be defined (i.e., the one-by-one comparison between all parameters should result in at least a certain percentage of identity between the two sources being compared). Above the threshold, the authentication is successful while below the threshold the authentication is not successful. For example, the threshold may be set to 100%, 80%, 60%, 50% or any other suitable value. When the selected, matching parameters are being compared the outcome of the comparison is generally binary, that is either there is identity (i.e., the 2 parameters compared are identical) or there is no identity (i.e., the 2 parameters compared are not identical). In some instances, the comparison may show that there is only partial identity (e.g., the street addresses compared match but the postal codes do not). In this case, the outcome of the comparison may or may not be considered to be identical. In some cases, it will not be considered identical. In other cases, comparison with another source of information may be used to determine whether the partial identity is real or whether it is a result of a clerical error (e.g., when the postal code was entered in the relevant data set). Any other suitable configuration is possible in other embodiments.

If the authentication mechanism determines that a sufficient match exists between the sources of information, the user's account is opened. The user may be notified via the digital channel 221 that the account has been opened. In addition, the institution 212 may deposit an amount equal to the payment in the account or it may wait until it receives payment from the user's bank 214 before depositing the payment in the user's account. Alternatively, the user may be given the choice to reverse the funds, in other words to reverse the payment. In such an instance, the account is opened with the institution 212 but no funds are deposited in it.

If, on the other hand, the authentication mechanism determines that there is not a sufficient match between different sources of information, the payment may be refunded (or charged back) to the user's bank and the account may not opened. The user may then be notified via the digital channel 221 (for example via the institution website) that the payment has been reversed and the account has not been opened. In another example, the institution may open the account, but it may remain inaccessible to the user or restrictions on use of the account with the institution 212 may be implemented and remain in effect until a further information is received about the user. For example, the authentication mechanism may have determined that sufficient match between the sources of information exists, but the payment request was refused by the user's bank. The user may then be provided with an option to select another payment option within the user's digital wallet and/or may be required to successfully process a payment within a prescribed timeframe, at the end of which a failure to successfully process a payment will result in closure of the user's account with the institution 212. Alternatively, the user may not have submitted scans of a piece of identification and images and video of his face. He may now be prompted to do so and subsequently the authentication mechanism will determine whether there is sufficient match between the new information and the previously obtained information. If the authentication mechanism now determines that there is sufficient match, the restrictions on the account may be removed. If the new information does not provide sufficient match, the account may be closed, and the user may be notified via the digital channel 221 and the payment reversed. In a further example, once the user's institution account is opened it may not be readily usable by the user, for instance until the payment has been sent by the user's bank 214 and received by the institution 212, as further described below, which can take from several minutes to several days. In other non-limiting examples, the user's institution account may be readily usable instantaneously, with some limitations (e.g., in terms of the number and/or quantum of the transactions the user may be able to perform until the payment has been sent by the user's bank 214 and received by the institution 212) or without any limitation. The user may then be notified that the user's institution account has been opened, for example via a digital channel 221.

Accordingly, the system 200 may be used to implement the method 100 to authenticate a user by way of a user authentication mechanism associated with the digital wallet of the user, specifically with a payment option within the user's digital wallet in one non-limiting example. Since the user has already been authenticated by another party with the specific payment option associated with the digital wallet, there is a high level of certainty from the perspective of the institution 212 opening the new account in terms of the identity of the user. In other words, the institution 212 is more likely to know who the individual associated with the digital wallet is by piggybacking on the authentication that was carried out by another party to open the account with the specific payment option within the digital wallet. The biometric identification mechanism for opening an account with a digital wallet establishes that the person who operates the digital wallet and confirms the payment at step 118 to the institution 212 to open the new institution account is likely the individual that lawfully owns the digital wallet. Accordingly, this method, in addition to the other sources of information, constitutes a highly reliable and robust authentication mechanism.

With further reference to FIG. 5A, when the user accesses the digital channel 221 (which in this example is the institution's website) at step 110 via a browser, a User Interface (UI) is generated by, or on behalf of, the institution 212. While in this example, the UI is accessed by way of the computer 220 in data communication with the Internet 210, it will be understood that the UI can be accessed by any suitable digital channel 221, including but not limited to the mobile device 222 (e.g., a smartphone or tablet device). FIG. 5 shows one non-limiting example of a UI generated by, or on behalf of, the institution 212, at step 110, the UI comprising various graphical control elements arranged to enable the user to request an account opening.

In this non-limiting example, the user is presented via the user's browser 500 with a UI comprising a plurality web forms 501 and 502. Any other suitable number of web forms is possible in other non-limiting examples. In this non-limiting example, the plurality of web form comprises a Personal Details section 501 and a New Account Information section 502. The Personal Details section 501 generally includes form fields and graphical control elements that allow the user to input personal details. In this non-limiting example, the Personal Details section 501 includes fields for entering the user's first name, middle name, last name, address, postal/ZIP code daytime and mobile telephone numbers and email address. The Personal Detail section may also include fields for entering the user's bank 214 and user's bank account details related to the activation of the payment option by the user at step 116, where applicable, as further described in connection with the Account Creation Deposit section 503 below.

The plurality of web forms also comprise a New Account Information section 502, which generally includes form fields and graphical control elements that allow the user to make choices in relation to the services required with the institution 212. In the non-limiting example of FIG. 5, the institution 212 is a financial institution, specifically a bank, such that the New Account Information section 502 allows the user to select which type of account they would like to open with the bank (e.g., checking, savings, etc.) and how account statements should be communicated to the user. It will be understood that other pieces of information and/or other account-related, bank-related or user-related options could form part of the UI in this non-limiting example. Any other suitable configuration of the UI may be possible in other embodiments.

By completing the various elements of the plurality of web forms as described above and engaging the SUBMIT button on the UI, the information from the plurality of web forms may be sent to the institution 212 and the user then request to open an account at step 112.

In some non-limiting examples, with further reference to FIG. 5B, once the information from the plurality of web forms has been sent to the institution 212 after engaging the SUBMIT button on the UI as described above, a second, distinct UI may be presented to the user via the user's browser 500 with at least one web form. In some non-limiting examples, the second UI may be generated by, or on behalf of, the institution (for example when the institution is Payment Card Industry Data Security Standard “PCI” compliant), or it can also be generated by, or on behalf of, a distinct entity in other non-limiting examples. For instance, the second UI may be generated by a PSP or any other suitable entity distinct from the institution 212 depending on the payment option that has been chosen by the user within the digital wallet. The second UI comprises at least one web form comprising an Account Creation Deposit section 503, which generally includes form fields and graphical control elements that allow the user to select the payment details required to activate the payment option at step 116 (i.e., activation of payment option and payment confirmation). Furthermore, the Account Creation Deposit section 503 may also enable the user to specify the amount of money for the payment, as well as the payment method. In the non-limiting example of FIG. 5, the amount entered is $100 and the exemplary payment method options provided are XYZ Pay, ABC Pay and PAYLY. Any other suitable means of payment may be possible in other non-limiting examples, such as but not limited to credit cards (i.e., VISA®, MasterCard®, etc.), debit cards, pre-paid cards, for example accessible via PayPal® or Venmo®, payment handlers such as Apple Pay®, Google Pay® or Samsung Pay® and the likes.

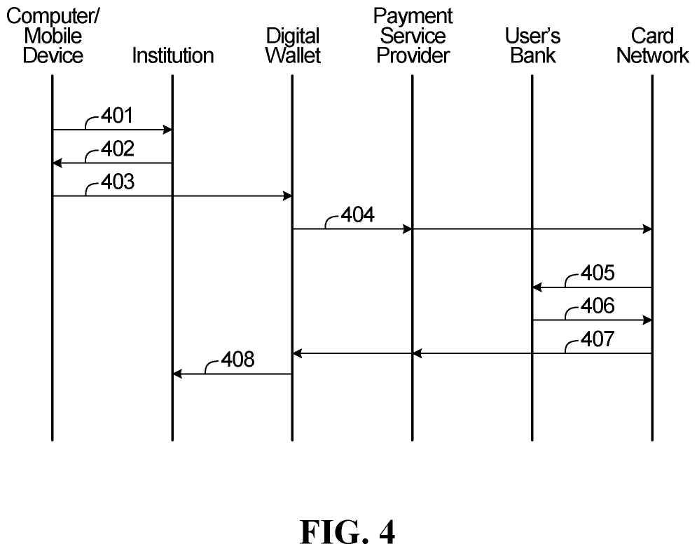

With further reference to FIG. 3, a flowchart illustrating the steps of a method 300 for identifying and authenticating a user for the purpose of opening an account with the institution 212 using the system 200 is shown, with a particular emphasis on how a payment is sent from the user's bank 214 to the institution 212. FIG. 4 is a high-level network transmission diagram relating to the financial data communication transmissions involved in the method 300 of FIG. 3.

In the following non-limiting example, the user accesses a digital channel 221, in this example a website of the institution 212 (transmission 401) using the computer 220 or the mobile device 222 connected to the Internet 210 and uses a service or device configured for making electronic transactions, specifically a digital wallet comprising an application running on the user's computer 220 or mobile device 222 and a remote server. Still in the following non-limiting example, a basic tokenization-based payment methodology is used, based in part on the EMV™ Payment Tokenisation Specification, such that the credit or debit card information is tokenized and only the tokens are communicated to the wallet and PSP. Any other suitable service or device configured for making electronic transactions may be used, separately from or concurrently with the digital wallet described above, in other non-limiting examples.

At step 310, in response to the user accessing the digital channel 221 of the institution 212, in this non-limiting example the website of the institution 212, and making a request to open an account with the institution 212 (transmission 401), the institution 212 requests, via the digital channel 221 (transmission 402), a payment by the user via the user's digital wallet. At step 312, the user chooses a payment option with the chosen digital wallet in response to the payment request received at step 310 using the payment options available in the user's digital wallet (transmission 403), the digital wallet being typically associated with, and comprising information pertaining to, a plurality of payment options of the user, such as, but not limited to, a credit card of the user, a debit card, a pre-paid card, for example accessible via PayPal® or Venmo® credentials, payment handlers such as Apple Pay®, Google Pay® or Samsung Pay® and the likes. Still at step 312, communication with the digital wallet (transmission 403) is used to identify the user, as described above, using encrypted information generated by the digital wallet. It is appreciated that, at step 312, the UI that is being generated to provide the option to the user to activate the payment option may be generated by, or on behalf of, the PSP 211 or the user's bank 214.

In this non-limiting example, the user chooses as payment option a virtual credit card within the digital wallet, the virtual credit card being associated with the card network 216. After the selection of the virtual credit card, at step 314 the payment is confirmed by the user and the user is further identified by way of the user identification functionality associated with the digital wallet, as further described above. In this example, the user is identified by the face recognition feature of mobile device 222, although other user authentication mechanisms are possible, as outlined above.

At step 316, the digital wallet sets up a Secure Socket Layer (SSL), or other form of secured communication channel, with the card network 216 and sends a token and payment request (along with information pertaining to the institution 212) to the card network 216 (transmission 404). In a preferred example, a communication may be sent between the digital wallet and the PSP 211 such that the digital wallet sends the token and payment request to the card network 216 via the PSP 211. At step 318, the card network 216 converts the token into a credit card number of the user (notably using cryptogram passwords sent from the server of the digital wallet to the card network 216), and then sends the credit card number of the user and the payment request to the user's bank 214 (i.e. the bank associated with the credit card being used to settle the payment) by way of transmission 405, which is also preferably secured and/or encrypted.

At step 320, the user's bank 214 verifies that the funds requested are available and sends an authorisation message to the card network 216 by way of transmission 406. In addition, the user's bank 214 may send payment information, the payment information including information related to the user, to the card network 216 by way of transmission 406. The payment information may include payer identity information. Payer identify information is defined herein as any suitable information relating to the identity of the payer. Such information can include, but is not limited to, the full name, address, email, phone number, and postal/ZIP code of the payer and/or banking details of the payer, such as the bank ID and/or all of part of the bank account details of the account used by the payer to make the payment. At step 322, the card network 216 then sends any payment information and the authorisation message to the digital wallet by way of transmission 407. In a preferred example, when communication has been sent between the digital wallet and the PSP 211 at step 316, the card network 216 may send any payment information and the authorisation message directly to the digital wallet via the PSP 211. Alternatively, the payment information and authorisation message may be sent to the institution 212 directly.

At step 324, the institution 212 receives the authorization and any payment information from the digital wallet. The institution then compares at least two of any payment information received from the user's bank 214, the information submitted by the user when the user made the request to open the account with the institution 212 at step 112, the third party provided information, information obtained from scans of identification cards and images and videos of the person, and the digital wallet provided information, as further described above. If there is a minimum match between the various sources of information, the institution 212 opens the new account and may deposit a sum (associated with the amount included in the initial payment request) into the user's new account with the institution 212 at step 332. Then at step 334, the user is notified via the digital channel (in this example the institution website) that the account has been opened. In some non-limiting examples, the institution 212 can prepare and send account/card setup information to the digital wallet at step 336. Account/card setup information is used by the digital wallet to add the new account, or a card associated with the new account, to the digital wallet

If on the other hand, a minimum amount of payer identity information does not match the information at step 326, the institution 212 notifies the user of a discrepancy at step 328, and reverses the payment or returns the payment to the account at the user's issuing bank 214 at step 330.

It will be appreciated that there are multiple ways of adding the new account and/or card to the digital wallet, depending on the form of the digital channel used by the user. If the digital wallet is accessible on the device (e.g., the computer 220 or the mobile device 222) being used to access the institution's website and relevant credit card information has been added via the application, then the setup information can be provided directly to the digital wallet via the application and the new account and/or card opened at the institution can be added to the digital wallet. If, on the other hand, the relevant credit card information has not been entered via the application of the digital wallet, then the account/card setup information can first be sent from the server of the digital wallet to the device being used to access the institution's website, and then be sent from the server of the digital wallet to the device upon which the application of the digital wallet is located. It will be appreciated that the transmission of the account/card setup information from the digital channel being used to access the institution's website to the device upon which the application of the digital wallet is located can be done any number of suitable ways, including but not limited to Bluetooth communication transmission, Wi-Fi transmission, NFC transmission, or any other suitable electromagnetic data transmission technology. Additionally, a digital channel in communication with the digital wallet's server can also be used to add the new account/card to the digital channel, for example via voice command over a voice assistant.

FIG. 6 represents an alternative backend payment system for enabling the method 100 in accordance with yet another embodiment. In one non-limiting example, the user enters information into the user's digital wallet (specifically, into the application running on the user's computer 220 or the user's mobile device 222), the information entered being required to use at least one payment option within the digital wallet. The information may be authenticated within the user's digital wallet by any suitable means (e.g., the name of the user, the address and postal code, CSV, etc.). After being communicated to the digital wallet server via transmission 601, the digital wallet server creates, for the at least one payment option, a token and a plurality of cryptogram passwords associated with the particular mean of payment and such token and plurality of cryptogram passwords are then sent back to the mobile application running on the user's computer 220 or the user's mobile device 222, where the token and the plurality of cryptogram passwords are stored. In parallel, the digital wallet server also communicates the token and plurality of cryptogram passwords to the card network 216 via transmission 602.

The user then accesses a digital channel, for example the website of the institution 212 using the computer 220 or the mobile device 222 connected to the Internet 210 and makes a request to open an account with the institution via transmission 603. Upon the user choosing a payment option within the user's digital wallet (specifically, using the digital wallet application running on the user's computer 220 or the user's mobile device 222), the user is identified via a communication made with the digital wallet server or locally with the digital wallet and as described above, using for example a biometric-based identification mechanism associated with the digital wallet, and the institution website then relays the request to the PSP 211. In other non-limiting examples, the process may entirely bypass the institution website and the activation of the payment option within the digital wallet application running on the user's computer 220 or the user's mobile device 222 may be relayed directly to the PSP 211. The PSP 211 forwards the request to the institution 212 via transmission 605 and the institution 212 then forwards the payment request to the user's bank 214, first via the card network 216 via transmission 606, and then to the user's bank 214 via transmission 607. It will be appreciated that, in this non-limiting example, transmissions 603, 604, 605 and 606 may all be encrypted, and transmit tokenized information and be setup via a SSL or any other form of secure communication channel. Upon receipt of the request by the card network 216 via transmission 606, the cryptogram passwords received by the card network 216 via transmission 602 are used to extract credit card information, including a credit card number associated with the payment option selected within the digital wallet of the user, which is then communicated to the user's bank 214 via communication 607.

The user's bank 214 then confirms that the funds requested are available and sends an authorisation message and optionally payment information to the card network 216 via transmission 608, the payment information including information about the user with the bank 214. The card network 216 then relays the payment information and authorisation message to the institution 212 via transmission 609 which then compares the payment information with the information submitted by the user when the user made the request to open the account with the institution 212. As described above, if a minimum amount of payer identity information does not match this information submitted by the user, the institution 212 notifies the user of a discrepancy and reverses the payment to the account at the user's bank 214. The institution 212 relays the payment information and authorisation message to the PSP 211 via transmission 610. The PSP 211 then relays the payment information and authorisation message to the institution website via transmission 611 and then the institution website relays the payment information and authorisation message to the computer 220 or mobile device 222 via transmission 612. In other non-limiting examples, the payment information and authorisation message may be relayed directly to the computer 220 or mobile device 222 via the institution 212 or via the PSP 211. Any other suitable configuration is possible in other non-limiting examples.

The skilled reader will readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The embodiments are also intended to cover computers programmed to perform said steps of the above-described methods.

It should be appreciated by those skilled in the art that any block diagrams herein represent conceptual views of illustrative circuitry embodying the principles disclosed herein. Similarly, it will be appreciated that any flow charts and transmission diagrams, and the like, represent various processes which may be substantially represented in computer readable medium and so executed by a computer or processor, whether or not such computer or processor is explicitly shown.

Although various embodiments and examples have been presented, this was for purposes of description, but should not be limiting. Various modifications and enhancements will become apparent to those of ordinary skill in the art.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

1. A method for an institution to open an account for a user, the method comprising:
receiving a request from the user to open the account with the institution;
asking the user, via a digital channel, for a payment from a digital wallet of the user;
identifying the user at least in part by receiving information about the user from the digital wallet and using an outcome of an identification method associated with the digital wallet; and
opening the account with the institution,
wherein a payment request is made to the digital wallet from an issuing bank of the user after the identifying of the user.

2. A method as defined in claim 1, further comprising prior to the step of opening the account with the institution:
obtaining an authorisation message originating from the issuing bank of the user for a payment option associated with the payment request, such message associated with the payment request.

3. A method as defined in claim 1, wherein the identification method associated with the digital wallet is a biometric method.

4. A method as defined in claim 1, further comprising:
requiring the user to submit, via a digital channel, images of an identification card, such identification card showing information, including at least one of an image of at least one part of a person, a name, address, age, and gender;
processing said image to obtain the information;
comparing the obtained information to the information received about the user from the digital wallet; and
opening an account with the institution if the comparing is above a pre-specified threshold.

5. A method as defined in claim 4, further comprising:
requiring the user to submit at least one image of the user's face via the digital channel; and
comparing the image of the user's face to the image of the person on the identification card; and
opening an account with the institution if:
comparing the obtained information to the information received about the user from the digital wallet is above the pre-specified threshold; and
comparing the image of the user's face to the image of the person on the identification card is above a second pre-specified threshold.

6. A method as defined in claim 1, further comprising:
prior to opening the account with the institution, obtaining payment information originating from the user's issuing bank for the payment option associated with the payment request, such payment information associated with the user;
comparing such payment information with information obtained from the digital wallet; and
opening the account with the institution if the comparing is above a pre-specified threshold

7. A method for an institution to open an account for a user, the method comprising:
receiving a request from the user to open the account with the institution;
requesting a payment from a digital wallet of the user;
identifying the user based on (i) at least one set of information about the user received from an information repository and (ii) at least one set of information inputted by the user;
comparing the at least one set of information received from the information repository and the least one set of information inputted by the user;
authenticating the user when the comparing meets a pre-determined threshold; and
opening the account with the institution.

8. A method as defined in claim 7, wherein the at least one set of information inputted by the user corresponds to information received concurrently with the request from the user to open the account with the institution.

9. A method as defined in claim 7, wherein the at least one set of information inputted by the user corresponds to information inputted by the user when the user set up the digital wallet.

10. A method as defined in claim 9, wherein the information inputted by the user at the digital wallet of the user is biometric.

11. A method as defined in claim 7, wherein the at least one set of information inputted by the user corresponds to image, video or audio information inputted by the user.

12. A method as defined in claim 7, wherein the information repository is linked to the digital wallet of the user.

13. A method as defined in claim 7, further comprising receiving a payment authorization message from an issuing bank of the user after opening the account with the institution.

14. A method for an institution to open an account for a user, the method comprising:
receiving a request from the user to open the account with the institution;
requesting a payment from a digital wallet of the user;
identifying the user based on a plurality of sets of information received from a plurality of information repositories of the user;
comparing the plurality of sets of information received from the information repositories;
authenticating the user when the comparing meets a pre-determined threshold; and
opening the account with the institution.

15. A method as defined in claim 14, wherein the plurality of information repositories comprises the digital wallet of the user.

16. A method as defined in claim 14, wherein (i) the identifying the user further comprises identifying the user based on at least one set of information inputted by the user (ii) the comparing further comprises comparing the plurality of sets of information received from the information repositories and the least one set of information inputted by the user.

17. A method as defined in claim 16, wherein the at least one set of information inputted by the user corresponds to information received concurrently with the request from the user to open the account with the institution.

18. A method as defined in claim 16, wherein the at least one set of information inputted by the user corresponds to information inputted by the user at the digital wallet of the user.

19. A method as defined in claim 18, wherein the information inputted by the user at the digital wallet of the user is biometric.

20. A method as defined in claim 16, wherein the at least one set of information inputted by the user corresponds to image, video or audio information inputted by the user.
